(19) United States
(12) Patent Application Publication
(10) Pub. No.: US 2013/0046711 A1
(43) Pub. Date: Feb. 21, 2013

(54) System and Method to Determine Airline Baggage Allowance and Calculate Airline Baggage Fee

(71) Applicant: Tim B. Reiz, Doral, FL (US)

(72) Inventor: Tim B. Reiz, Doral, FL (US)

(73) Assignee: Farelogix, Inc., Miami, FL (US)

(21) Appl. No.: 13/210,819

(22) Filed: Aug. 16, 2011

(51) Int. Cl. G06Q 30/00

(52) U.S. Cl. 705/400

(57) ABSTRACT

A system and method are provided to process a traveler's profile, itinerary, airfare ticket data, and baggage details to determine baggage allowance and calculate applicable baggage fees based on the rules provided by one or more airline. The system automatically determines how to best associate each bag to an individual traveler so that a party of multiple travelers pays the lowest possible baggage fees.

### BACKGROUND

1. Field of the Invention

The invention is in the field of software for airline content distribution, and more specifically, software for airline itinerary-specific baggage fee calculations.

2. Description of the Prior Art

Conventional airline reservation systems, web sites, and check-in systems provide catalog-style information and rules on baggage fees to be charged to a traveler. The current procedure to calculate baggage fees is a manual process in which the traveler or reservation agent determines the baggage allowance for each traveler in a party, decides how to best distribute the bags amongst travelers, and then calculates baggage fees if applicable.

An increasing number of rules which adjust baggage fees based on a multitude of variables make it difficult for consumers, airline staff, and travel agents to determine the correct baggage allowance and fee amounts so as to minimize costs to the traveler. A partial list of these variables includes: traveler type (e.g., adult, child, military), traveler's status with the airline (e.g., participation in a loyalty or “frequent flier” program); flight origin and destination; flight routing; mileage (i.e., distance to be traveled); travel date(s); advance ticket purchase; type of aircraft; cabin assignment (e.g., first class, coach); ticket fare; ticketed airline; codeshare agreements; airline(s) used for connections) (e.g., interline connections versus single line); luggage type (e.g., regular bag versus ski or golf equipment); bag occurrence (e.g., 1^{st} checked bag, 2^{nd} checked bag); bag weight; bag dimensions (e.g., in linear units, the sum (in inches or centimeters) of the length plus width plus depth of a bag); and currency conversions.

As more and more airlines define their own baggage allowances and charges based on these variables, the complexity of assessing baggage allowances and fees increases tremendously. Even for purely domestic travel (i.e., where the travel origin, destination, and furthest intermediate stopover are all within the United States), the calculation of the baggage fees may be complex because of the number of variables contributing to the fee, despite there being only one set of baggage rules from one airline (the baggage rules and charges of the marketing airline) to be applied. Regardless of the number of stopovers, United States Department of Transportation (DOT) regulations mandate that a single baggage fee is charged for each direction of an itinerary (i.e., one charge going to a destination and one charge returning from the destination), (DOT Order 2009-9-20, published at http://www.regulations.gov/#!documentDetail;D=DOT-OST-2008-0367-0002).

For interline passenger travel, the complexity of calculating baggage fees increases manyfold because baggage fees are not limited to single inward and outward bound fees. Travel agents and check-in agents may not have access to baggage policy information for all carrier airlines involved in the itinerary, and as a consequence, agents may not be able to advise travelers on free baggage allowances (including baggage dimensions and weight), or on fee schedules for allowable or excess baggage. The result of this confusion is that passengers receive inconsistent, if not incorrect information about baggage fees and the airlines lose revenue.

This problem has been recognized by the international industry trade group of airlines (International Air Transport Association, “IATA”) which implemented new regulations (IATA Resolution 302, effective Apr. 1, 2011) to determine which airline's baggage rules and fees are to be applied on an interline (including codeshare and alliance carrier) itinerary. Resolution 302 requires airline carriers to establish baggage rates and make that information available to travelers during booking and check-in. The resolution establishes a four-step process to determine the controlling baggage provisions, as follows: (1) if all carriers participating (“participating carriers”) in the interline itinerary have published the same baggage provisions, those provisions apply; (2) if the participating carriers for the interline itinerary have published different baggage provisions, any common provisions shared by the participating carriers apply. For baggage provisions that differ between/among the carriers, the baggage provisions of the Most Significant Carrier (defined based on carrier airline when crossing IATA-designated geographical sectors of the world) control. If the interline itinerary includes codeshare flights, the provisions of the operating carrier control, unless that carrier publishes a stipulation ceding control to the marketing carrier; (3) if the most significant carrier has not published baggage provisions for the itinerary, the published baggage provisions of the carrier accepting the baggage at check-in apply; and (4) if the carrier accepting the baggage at check-in has not published baggage provisions for the itinerary, the published baggage provisions of each airline are applied on a sector-by-sector basis.

The current DOT and IATA regulations to determine carrier priority for applying baggage fees and the number of variables contributing to baggage pricing effectively eliminate the possibility of manual determination of controlling baggage rules and manual calculation of baggage fees. IATA has recognized that adoption of its Resolution 302 is indeed too complex to be manually applied, and that a need exists for an automated process to implement the mandated baggage rules and fees.

### SUMMARY

In one embodiment is provided a method of determining airline baggage allowance and calculating baggage fees comprising: receiving airline schedule information at a first computing system across a first network connection from a second computing system, the airline schedule information comprising schedule information for one or more airline; storing the received airline schedule information in a schedule store; receiving baggage rules at a first computing system across a second network connection from a third computing system, the baggage rules comprising baggage allowance information and baggage fee information for one or more airline; storing the received baggage rules in a baggage rules store; receiving trip data for two or more travelers each with one or more bag at a first computing system across a third network connection from a client system; determining a bag travel route and a governing airline for the bag travel route by accessing the schedule store based on the received trip data; determining applicable baggage allowance rules and applicable baggage fee rules for the bag travel route on the determined governing airline by accessing the baggage rules store based on the received trip data; enumerating baggage distribution patterns of the two or more travelers, the one or more bag, and a bag order for the bag travel route on the determined governing airline; calculating baggage fees for the enumerated patterns based on the determined applicable baggage allowance rules and the determined applicable baggage fee rules; comparing the baggage fees for the enumerated patterns and selecting the pattern with a lowest-priced baggage fee; and transmitting from the first computing system across the third network connection to the client system the selected pattern and the baggage fee for the selected pattern.

In another embodiment is provided a non-transitory computer readable medium having stored thereupon computing instructions comprising: a code segment to receive airline schedule information at a first computing system across a first network connection from a second computing system, the airline schedule information comprising schedule information for one or more airline; a code segment to store the received airline schedule information in a schedule store; a code segment to receive baggage rules at a first computing system across a second network connection from a third computing system, the baggage rules comprising baggage allowance information and baggage fee information for one or more airline; a code segment to store the received baggage rules in a baggage rules store; a code segment to receive trip data for two or more travelers each with one or more bag at a first computing system across a third network connection from a client system; a code segment to determine a bag travel route and a governing airline for the bag travel route by accessing the schedule store based on the received trip data; a code segment to determine applicable baggage allowance rules and applicable baggage fee rules for the bag travel route on the determined governing airline by accessing the baggage rules store based on the received trip data; a code segment to enumerate baggage distribution patterns of the two or more travelers, the one or more bag, and a bag order for the bag travel route on the determined governing airline; a code segment to calculate baggage fees for the enumerated patterns based on the determined applicable baggage allowance rules and the determined applicable baggage fee rules; a code segment to compare the baggage fees for the enumerated patterns and to select the pattern with a lowest-priced baggage fee; and a code segment to transmit from the first computing system across the third network connection to the client system the selected pattern and the baggage fee for the selected pattern.

In another embodiment is provided a baggage pricing system comprising: a schedule store configured to store airline schedule information for one or more airline, the airline schedule information comprising schedule information for one or more airline; a baggage rules store configured to store baggage rules for one or more airline, the baggage rules comprising baggage allowance information and baggage fee information for one or more airline; and a computing system coupled to the schedule store, the baggage rules stores, and a client application communicating with the computing system by means of a web services XML interface, the computing system configured to receive trip data for two or more travelers each with one or more bag from the client application and to determine baggage allowance and baggage fees based on the airline schedule information retrieved from the schedule store, the baggage rules retrieved from the baggage rules store, and the trip data retrieved from the client application.

### BRIEF DESCRIPTION OF THE VARIOUS VIEWS OF THE DRAWING

FIG. 1 is a block diagram of an exemplary Baggage Fee Calculation System.

FIG. 2 is a flowchart of an exemplary method of determining airline baggage allowance and calculating baggage fees.

FIG. 3 is a schematized diagram of exemplar bag travel routes among several airports.

FIG. 4 is a process flow to determine a bag travel route.

FIG. 5 is a table of Optional Services Industry Sub Codes published by ATPCO.

FIG. 6 is a table showing a full combinatorial matrix for two travelers, each with three bags, including permutations with bag occurrence.

### DETAILED DESCRIPTION

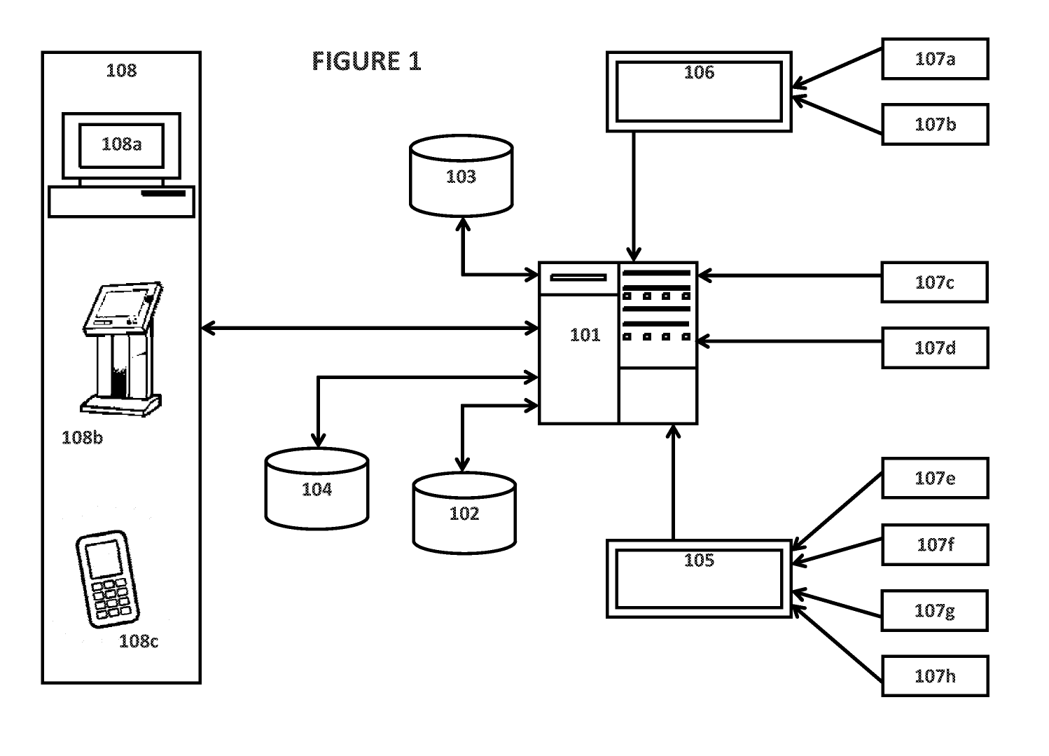

A system and a method are provided to process travelers' profiles, itineraries, airfare ticket data, and baggage details to determine baggage allowance and calculate applicable baggage fees based on baggage allowance and pricing rules provided by one or more airlines. The system comprises a computing system running a software application which receives baggage fee and allowance information from one or more airline, stores that information centrally, receives from a client application information detailing trip data for two or more travelers, determines (based on stored baggage fee and allowance information) how to best distribute travelers' baggage between or among the travelers to minimize baggage fees, and outputs one or more baggage distribution pattern minimizing baggage fees and the associated fee(s) to the client application. One embodiment of these systems and methods is shown in FIG. 1.

FIG. 1 is a block diagram of systems and methods as described herein to determine airline baggage allowance and to calculate baggage fees. A computing system 101 (preferably a computer server) is connected via a network connection to a schedule store 102, a baggage rules store 103, and optionally a currency conversion store 104. Computing system 101 accesses these data stores to process baggage allowance and baggage pricing requests initiated by client applications. One of ordinary skill in the art will understand that these data stores may be connected to computing system 101 via a wide area network (WAN), a local area network (LAN), a global area network (GAN), a virtual private network (VPN), a personal area network (PAN), an enterprise private network, or any similar network now known or later developed.

Computing system 101 is also connected via a network connection to a client system 108 through which baggage allowance and baggage pricing requests are initiated. The interface provided to client applications is, in one embodiment, a Web Services Extended Markup Language (XML) interface and includes methods to determine baggage allowance and calculate baggage fees.

One of ordinary skill in the art will understand that known network connections include an integrated services digital network (ISDN), a broadband ISDN (B-ISDN), a digital subscriber line (ADSL, ADSL+2), a symmetric digital subscriber line (SDSL), a very high speed DSL (VDSL), cable, wireless, a broadband internet connection, a T-1 line, a bonded T-1 line, a T-3 line, an optical carrier level 3 (OC3), a satellite, or any other form of network connection now known or later developed.

Schedule Store 102 is a data store containing airline schedule information for one or more airline. Computing system 101 receives airline schedule information across a network connection from a computing system of a provider of global airline information 105 which itself receives information directly from one or more airline 107e, 107f, 107g, and 107h. One such global provider 105 is OAG Aviation (“OAG”) with which company almost all domestic and international airlines file their flight schedules, as well as equipment details and operating carrier information. Providers of distribution technology and sendees typically subscribe to a daily feed with OAG or a similar provider to store the flight schedule data (and associated data) locally in a company data store (e.g., schedule store 102). Computing system 101 preferably subscribes to receive updated airline schedule information daily from OAG or a similar global provider 105.

Baggage Rules Store 103 is a data store containing baggage rules for allowance and fees. Computing system 101 receives baggage rules across a network connection from a computing system of a publisher of airline fare information 106 (which itself receives baggage rules and pricing data from domestic and international airlines 107a and 107b), and stores the data in baggage rules store 103. As is known in the industry, baggage rules data include, but are not limited to, allowance details, baggage fees, special gear rules and fees, flight number, and equipment type restrictions, cabin restrictions, purchase date and time windows, travel date and time restrictions, routing maps, class of service tables, frequent flyer levels, ticketed air fare, and some tax information that contribute to the fees. One such publisher is the Airline Tariff Publishing Company (ATPCO), which receives fare data from more than 300 domestic and international airlines. Providers of distribution technology and services typically subscribe to an hourly feed with ATPCO or a similar provider to store fare data locally in a company data store (e.g., baggage rules store 103). Computing system 101 preferably subscribes to receive updated fare data hourly from ATPCO or a similar publisher 106, although computing system 101 may also receive baggage rules directly from one or more airline 107c and 107d.

Currency conversion store 104 is a data store containing currency information and conversion rates. Computing system 101 receives the currency and conversion information (preferably daily) across a network connection from a provider such as the International Air Transport Association (IATA) or a multinational information technology company such as SITA, and stores the data locally in data store 104.

One skilled in the art will understand that the data stored in schedule store 102, baggage rules store 103, and currency conversion store 104 may be stored as separate stores, or combined in one data store. One of ordinary skill in the art will further recognize that the data stores can be a relational database (e.g., without limitation, Microsoft SQL server, MySQL, Oracle, or PostgreSQL), an object-oriented database (e.g., without limitation Caché, or ConceptBase), an operational data store, or a schema-less data store such as a distributed data store (e.g., without limitation, Apache, Cassandra, or Dynamo).

Baggage allowance and pricing requests are initiated by client applications 108. One of ordinary skill in the art will recognize that the client applications can be run on a number of platforms where requests can be initiated in a number of ways including, without limitation, by consumer or travel agency web sites 108a, travel agents, airline reservation agents, or travelers at check-in kiosks 108b, or traveler self-service applications 108c running on mobile devices such as, without limitation, personal computers, smartphones or electronic tablets.

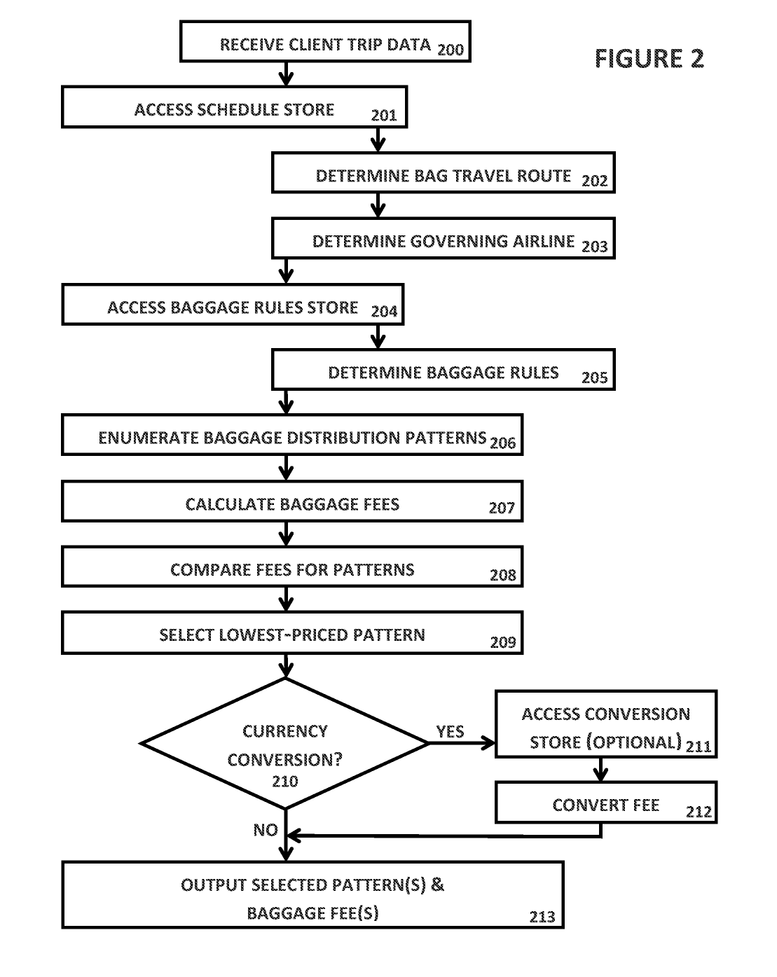

The method of determining airline baggage allowance and calculating baggage fees comprises a sequence of procedures designed to identify and minimize the baggage fee charged for a traveler's itinerary. The process flow is illustrated in FIG. 2. In step 200, the process begins when client trip data is received by computing system 101 from client application 108. Client trip data comprise details about a traveler's itinerary, and preferably include, without limitation, flight dates, flight numbers, fare(s), booking class(es), passengers (number, type, and status), and baggage details (number of bags, type (e.g., bag, sports equipment), weight, and size (e.g., large, small, or the physical dimensions)). One of skill in the art will understand that trip data may also be provided by scanning a barcode from an electronic ticket, from which scan flight data can be extracted. Client data can also include output preferences, e.g., whether only the lowest-priced baggage distribution pattern should be output from computing system 101 to client application 108, or whether multiple options should be output. Other request options presented through the XML interface can include, without limitation, allowing a user to specify (1) an association of bags to specific traveler(s), (2) an occurrence for one or more specific bag(s), (3) an Industry Sub-Code to a specific bag, and (4) a currency in which to report the output. By selecting various request options, a user can tailor the output to be received by client application 108 from computing system 101. As an example, a user can specify via the request options that the output be restricted to a baggage distribution pattern in which bag 2 is assigned as the first bag to traveler 2. If the resultant output is unacceptable, a user can make a subsequent request with different request options (e.g., for a different baggage distribution pattern). One of skill in the art will understand that an application user (the traveler or otherwise) may input these data manually, or may select pick-and-choose options presented to the user by the graphical user interface of the client application software.

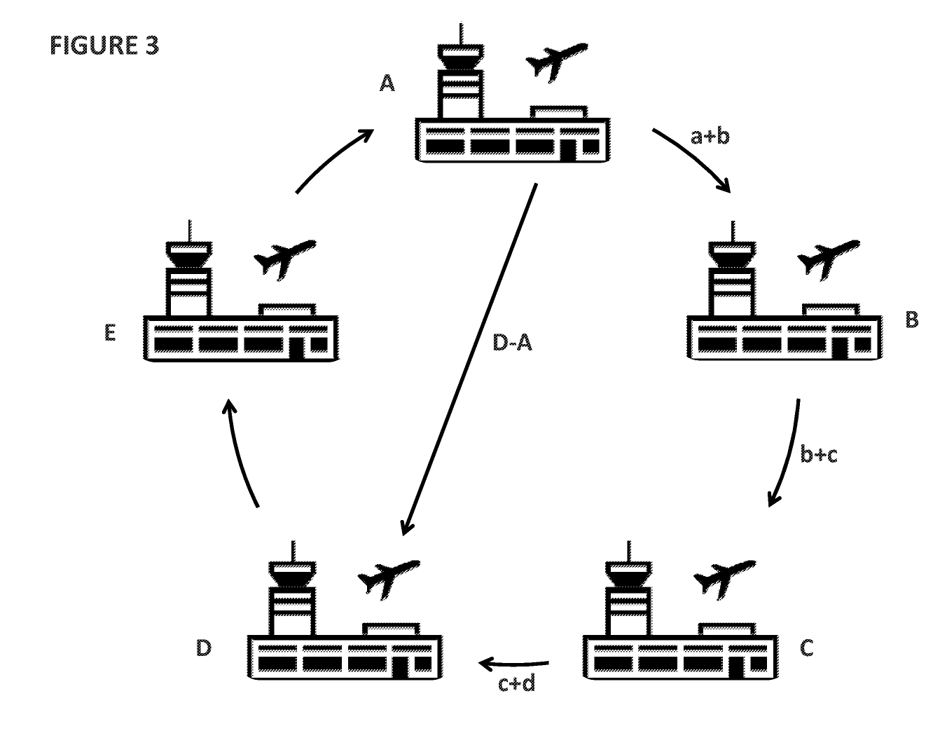

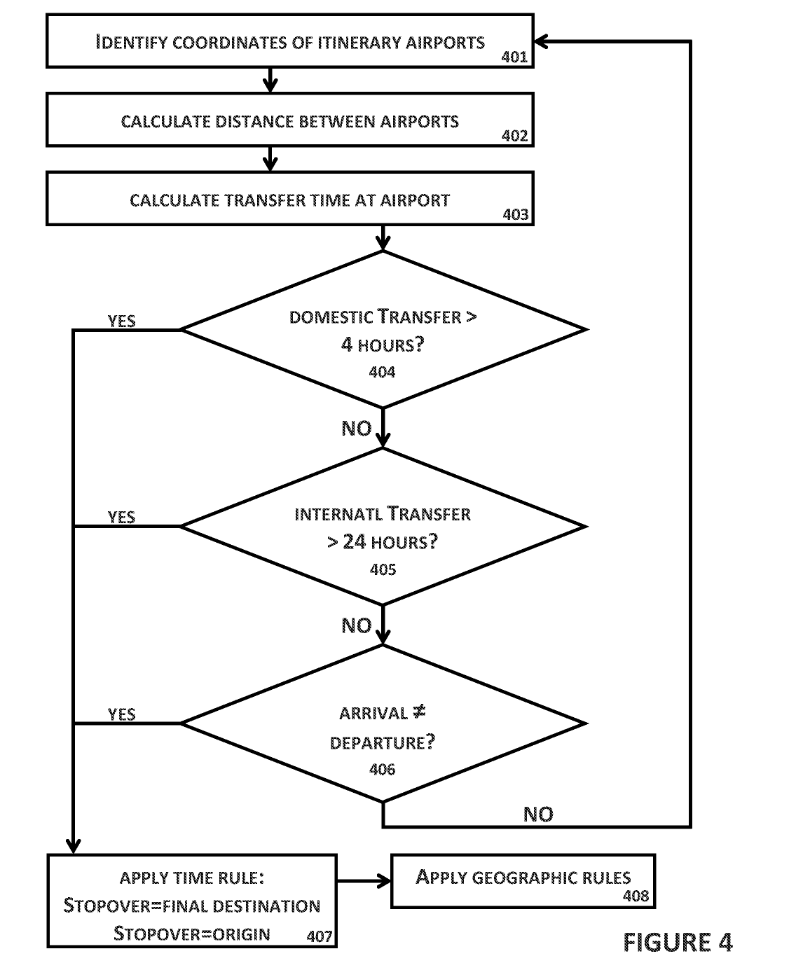

In step 201, computing system 101 accesses schedule store 102 to enhance trip data received in step 200. More particularly, computing system 101 retrieves from schedule store 102 additional flight details for the itinerary such as, without limitation, the exact time(s) of the flight(s), routing, stops (e.g., number of stops, time of stops, location, and duration of stops), operating carrier airline, and aircraft equipment type(s). In step 202, computing system 101 analyzes the data obtained in steps 200 and 201 to determine a bag travel route. As is known in the art, the bag travel route includes two or more travel points: a check-in origin (the first airport in the itinerary), a final destination at which the bag is to be retrieved by the traveler from the airline, and optionally, one or more stopover airport. These travel points may be obtained from the received client trip data, or through the use of a process flow executed by computing system 101 (as explained elsewhere herein) to determine a bag travel route. Determination of the bag travel route will now be explained in more detail with reference to FIGS. 3 and 4 before returning to the process flow of FIG. 2

Because the bag travel route may comprise one or more stopover airport in addition to the check-in origin and final destination airports, computing system 101 identifies the bag travel route for each one or more leg (defined as a segment of travel between two airports) of the itinerary, and then determines for each one or more leg whether the one or more leg is contained within one logical trip (i.e., is an intermediate point between the origin and the final destination), or whether the one or more leg constitutes an origin for an additional trip. As a non-limiting example, and as shown in FIG. 3, the itinerary may include a first leg from the check-in origin A to stopover B, a second leg from stopover B to stopover C, and a third and final leg from stopover C to final destination D. In that case, legs D to E and E to A may comprise an additional trip.

Referring now to FIG. 4, a process flow to determine a bag travel route will be explained. In step 401, computing system 101 retrieves (from data stored locally within computing system 101) the longitude and latitude coordinates for each airport identified in the itinerary. In step 402, computing system 101 uses these coordinates to calculate a nautical mileage (i.e., distance) between each airport and its succeeding airport in the itinerary.

In step 403, computing system 101 uses flight data retrieved from schedule store 102 to determine a transfer time between flight legs by calculating the difference between an arrival time at the stopover for the first leg airline and a departure time for the second leg airline from the stopover. In step 404, computing system 101 determines whether the transfer time is more than four hours for a domestic flight within the United States. If the transfer time is greater than four hours, then a “time rule” of step 407 is triggered under which the stopover airport becomes the final destination, and the stopover airport (or the next departure airport) becomes a new check-in origin. In step 405, computing system 101 determines whether the transfer time is more than 24 hours for an international flight. If the transfer time is more than 24 hours, the time rule of step 407 is triggered, and the stopover airport becomes the final destination, and the stopover airport (or the next departure airport) becomes a new check-in origin. In step 406, computing system 101 determines whether the departure airport for the stopover is different than the arrival airport for the stopover. If the departure airport is different than the arrival airport for the stopover, the time rule of step 407 is triggered under which the stopover airport becomes a final destination and the departure airport becomes a new check-in origin.

This procedure is repeated until all origin and final destination airports have been identified for the itinerary. As a non-limiting example shown in FIG. 3, an itinerary may include a first leg from check-in origin A to stopover B and a second leg from stopover B to stopover C. If the layover at stopover C triggers the time rule, however, then stopover C becomes a final destination and stopover C becomes check-in origin C on a first leg from stopover C to final destination D.

In step 408, computing system 101 applies “geographic rules” to determine possible turn-around points (i.e., the furthest point on a return journey, also the point at which outbound travel on an itinerary becomes a return trip). Turn-around points are used to determine how to break down rules processing for fees and allowance. For example, on a Miami-Dallas-Miami round trip itinerary, the turn-around point is Dallas. Computing system 101 must process the rules and fees for the Miami-Dallas segment and then the rules and fees for the Dallas-Miami segment to ensure that a bag fee is collected twice (once for each direction). Dallas could, however, also be the turn-around point on a Miami-Dallas-Orlando itinerary, or merely a stopover (i.e., transfer) on a Miami-Dallas-Los Angeles itinerary. Without an analysis of the routing to determine the turn-around point(s), computing system 101 cannot identify itinerary segments which constitute endpoints at which baggage is retrieved and cannot process the appropriate fees and rules for each segment of the itinerary.

For a round-trip itinerary (i.e., an itinerary comprising outbound and inbound (i.e., return) travel), turn-around points are determined based on mileage calculations. For example, if the final destination airport for the final leg of a round-trip itinerary is within 50 miles of the check-in origin airport, then multiple turn-around points are determined based on mileage calculations from the check-in origin to all airports within the itinerary. Multiple turn-around points in a multi-stop circle trip can be calculated by comparing the direct distance between two airports with the actual distance that is the sum of all legs between the two. If the nautical mileage sum of all legs is larger than the direct distance by a high percentage (200% or more), then a turn-around point (or “break point”) is assumed. As a non-limiting example shown in FIG. 3, if the summed distance for a round-trip itinerary between check-in origin A and final destination D [(a+b)+(b+c)+(c+d)] is two times greater than the direct distance between check-in origin A and final destination D (D-A), then a turn-around point is assumed.

If, however, the itinerary involves only domestic travel within the United States, the itinerary falls under U.S. DOT reservation regulations. In this situation, the turn-around point is simply based on the furthest check-in destination in the itinerary from the first departure in the itinerary, regardless of the number of stops in the itinerary. After the geographic rules have been applied, computer system 101 continues with the next step in the process to determine baggage allowance and calculate baggage fees.

Returning to the process flow of FIG. 2, in step 203, computing system 101 determines a governing airline for each bag travel route. The governing airline is the airline whose rules will determine baggage allowance and fees. When multiple airlines are involved (i.e., an interline itinerary), computing system 101 applies U.S. DOT reservation regulations and IATA rules (both stored into computing system 101) to select, if applicable, the governing airline (i.e., the “Most Significant Carrier” in IATA parlance), as discussed above.

In step 204, computing system 101 accesses baggage rules store 103 to retrieve baggage allowance rules for the governing airline. Baggage allowance rules on any given airline may differ based on, without limitation, traveler type (e.g., without limitation, adult, child, military); traveler's status with the airline (e.g., participation in a loyalty or “frequent flier” program); flight origin and destination; flight routing; mileage (i.e., distance to be traveled); travel date(s); advance ticket purchase; type of aircraft; cabin assignment (e.g., first class, coach); ticket fare; ticketed airline; codeshare agreements; airline(s) used for connection(s) (e.g., interline connections versus single line); luggage type (e.g., regular bag versus ski or golf equipment); bag occurrence (e.g., 1^{st} checked bag, 2^{nd} checked bag); bag weight; bag dimensions (e.g., in linear units, the sum (in inches or cm) of the length plus width plus depth of a bag); and currency conversions.

In step 205, computing system 101 processes the retrieved rules with the trip data to determine the applicable baggage allowance and fees. Computing system 101 identifies the applicable baggage fee rules for each bag travel route by processing the travelers, bags, and bag occurrences associated with the itinerary. Baggage fee rules on any given airline may differ based on, without limitation, traveler type (e.g., without limitation, adult, child, military); traveler's status with the airline (e.g., participation in a loyalty or “frequent flier” program); flight origin and destination; flight routing; mileage (i.e., distance to be traveled); travel date(s); advance ticket purchase; type of aircraft; cabin assignment (e.g., first class, coach); ticket fare; ticketed airline; codeshare agreements; airime(s) used for connection(s) (e.g., interline connections versus single line); luggage type (e.g., regular bag versus ski or golf equipment); bag occurrence (e.g., 1^{st} checked bag, 2^{nd} checked bag); bag weight; bag dimensions (e.g., in linear units, the sum (in inches or centimeters) of the length plus width plus depth of a bag); and currency conversions.

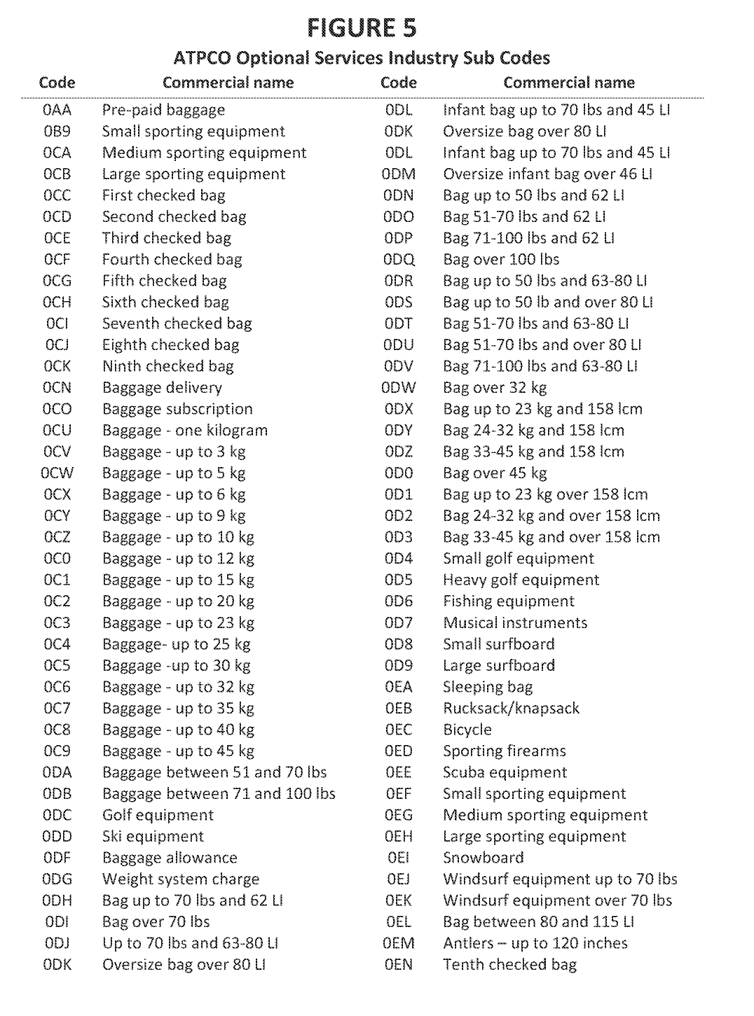

To process the retrieved rules with the trip data, computing system 101 selects, for each Bag (Bn), and per traveler (Tn), an applicable allowance record identifier and a weight charge record identifier from Industry Optional Services Sub Codes (also known as “Reason for Issuance Sub Code”) published by ATPCO and listed (in part) in FIG. 5. Baggage allowance and baggage fee records for each traveler can be depicted in a manner similar to the sample data presented in Table 1 below. An allowance record identifier (A:0DF) and a (fee) charges record identifier (C:0DG) are generated for each bag (Bn) and per traveler (Tn). In the example shown in Table 1, 0DG 595000 is a code for a regular bag in a weight concept system (i.e., where baggage fees are assessed based on bag weight, as opposed to being based on the number of pieces of baggage (a “piece” concept system)). (The number following the code (595000 in this case) is an internal record identifier. When multiple records filed with ODF exist, they may have different rule sets. As such, the record identifier is used to determine rules processing order.) The details of the allowance record identifier 0DF contains information on the free allowance (e.g., 20 kg), and the details of the fee record (charges record 0DG) contain the price per kg over the allowance. Other types of records may specify a piece concept (i.e., number of bags allowed instead of weight allowed) and charges for each additional piece. The record may also contain maximum weight and dimensions for an individual bag or item to be checked. The records selected match the type of bag. For example, if B1 were a special item such as a snowboard, a different record identifier (0EI) would be included in the result set.

TABLE 1
Exemplar Baggage Rules Processing Result Set

| Bag | Traveler | Allowance and Fee Record Result Set |
|---|---|---|
| B1 | T1 | A:0DF(140000)C:0DG(595000) |
| B1 | T2 | A:0DF(140000)C:0DG(595000) |
| B2 | T1 | A:0DF(140000)C:0DG(595000) |
| B2 | T2 | A:0DF(140000)C:0DG(595000) |
| B3 | T1 | A:0DF(140000)C:0DG(595000) |
| B3 | T2 | A:0DF(140000)C:0DG(595000) |

In step 206, computing system 101 enumerates combinatorial and permutational possibilities (collectively, “baggage distribution patterns”) for the number of travelers and the number of bags. For each bag travel route, and using a result set such as the exemplar result set of Table 1, the various combinations of assigning the bags to the travelers are generated. For example, all bags can be assigned to the first traveler, or all bags can be assigned to the second traveler, or bags may be distributed amongst the travelers in all possible combinations. Enumerating the various combinations can reduce fees because a traveler with a high loyalty status may have an allowance of three items of free baggage, while a non-status traveler may have an allowance of zero items of free baggage. To create the various combinations, the sequences of bags plus travelers are ordered using known mathematical processes, after which any combinations with unfeasible occurrences are discarded. As one non-limiting example, the traveler without a first bag cannot have a second bag, so that combination would be discarded.

Methods of enumerating combinations are known in the art, as described in a Wikipedia posting (http://en.wikipedia.org/wiki/Combination), hereby incorporated by reference in its entirety. With the preferred method, hardcoded in computing system 101, combinations are generated as follows: “[A]ll k-combinations of a given set S of n elements in some fixed order [are enumerated], which establishes a bijection from an interval of

$$( \begin{matrix}n \\ k\end{matrix} )$$

integers with the set of those k-combinations. Assuming S is itself ordered, for instance S={1,2, . . . , n}, there are two natural possibilities for ordering its k-combinations: by comparing their smallest elements first . . . or by comparing their largest elements first. The latter option has the advantage that adding a new largest element to S will not change the initial part of the enumeration, but just add the new k-combinations of the larger set after the previous ones. Repeating this process, the enumeration can be extended indefinitely with k-combinations of ever larger sets. If[,] moreover[,] the intervals of the integers are taken to start at 0, then the k-combination at a given place i in the enumeration can be computed easily from i, and the bijection so obtained is known as the combinatorial number system. It is also known as “rank”/“ranking” and “unranking” in computational mathematics,” (http://en.wikipedia.org/wiki/Combination, citing to Erwin Kreyszig, Advanced Engineering Mathematics, John Wiley & Sons, Inc. (1999) and Lucia Moura, “Generating Elementary Combinatorial Objects” (2009), accessible at http://www.site.uottawa.ca/˜lucia/courses/5165-09/GenCombObj.pdf)).

In addition to the combinations enumerated, permutations of combinations are enumerated for the occurrence of a bag (1^{st} bag, 2^{nd} bag, etc.) within a traveler association (e.g., 1^{st} bag for traveler 1, 2^{nd} bag for traveler 2, 1^{st} bag for traveler 2, etc.). These permutations are important because airlines charge different fees based on the occurrence of a bag, so the total fee may change depending on which type of bag is assigned to which specific occurrence. In one embodiment, the permutation process is limited to a maximum number of bags (preferably eight bags) in order to maintain reasonable processing times. Occurrences beyond that maximum number are assumed to be irrelevant based on rules typically filed by airlines.

Methods to enumerate permutations are also well known in the art, as described in a Wikipedia posting (http://en.wikipedia.org/wiki/Permutation), hereby incorporated by reference in its entirety. With the preferred method, hardcoded in computing system 101, permutations are generated as follows: “(1) Find the largest index k such that a[k]<a[k+1]. If no such index exists, the permutation is the last permutation. (2) Find the largest index l such that a[k]<a[l]. Since k+1 is such an index, l is well defined and satisfies k<l. (3) Swap a[k] with a[l]. (4) Reverse the sequence from a[k+1] up to and including the final element a[n].” After step 1, . . . all of the elements strictly after position k form a weakly decreasing sequence, so no permutation of these elements will make it advance in lexicographic order; to advance one must increase a[k]. Step 2 finds the smallest value a[l] [by which] to replace a[k] . . . , and swapping them in step 3 leaves the sequence after position k in weakly decreasing order. Reversing this sequence in step 4 then produces its lexicographically minimal permutation, and the lexicographic successor of the initial state for the whole sequence.” (http://en.wikipedia.org/wiki/Permutation).

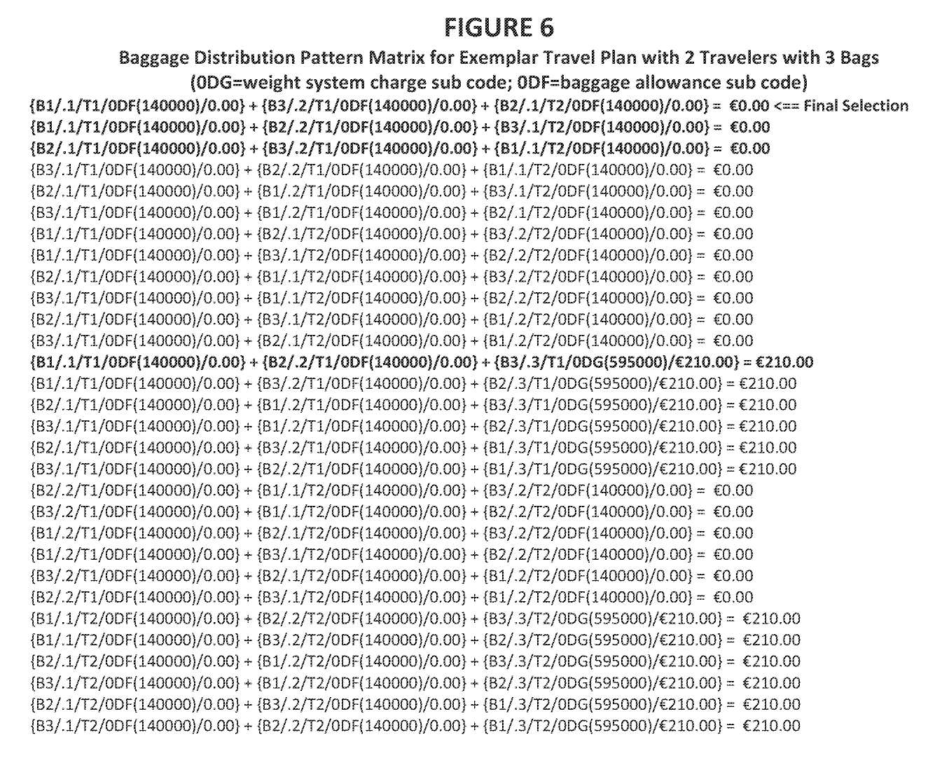

In step 207, computing system 101 calculates baggage fees for the enumerated baggage distribution patterns. A baggage distribution pattern matrix with calculated baggage prices for a sample itinerary with two travelers and three bags is shown in FIG. 6. Each row shows a possible distribution pattern for the number of bags in the party, the hypothesized occurrence of the bag (1^{st}, 2^{nd}, etc.), and the number of travelers. Rows are presented as the (Bag/Occurrence/Traveler/Record-ID/Price) for each component of a single distribution pattern. Within each distribution pattern, the individual components are ordered from left to right, starting with the free allowance component. The prices for each component are summed to generate a final price for each pattern. In the first row, for example, the first component (B1/.1/T1/0DF(140000)/0.00) indicates that bag 1 is assigned as the first bag to traveler 1 under a baggage allowance record 140000, with no fee charged for that arrangement. The second component (B3/.2/T1/0DF(140000)/0.00) Indicates that bag 3 is assigned as the second bag to traveler 1 under a baggage allowance record 140000, with no fee charged for that arrangement. The third component (B2/.1/T2/0DF(140000)/0.00) indicates that bag 2 is assigned as the first bag to traveler 2 under a baggage allowance record identifier ODF(140000), with no fee charged for that arrangement. Thus, if the bags are distributed within the party of travelers according to this pattern (or according to the distribution patterns presented in the next two highlighted rows), the total baggage cost incurred by the party is [symbol] 0.00. If all of the bags are assigned to a single traveler (as shown in the fourth highlighted row), however, the party of travelers (or at least traveler 1) will incur a baggage fee of [symbol] 210.00.

Another sample baggage distribution pattern matrix (generated for an itinerary with three adults and one child with five bags, one of which is a stroller and one of which is a bike) is presented in Appendix A. Although the full matrix of baggage distribution patterns and fees considered by computing system 101 for this scenario contains thousands of combinations and permutations, only a subset is presented in the appendix. As can be seen in the highlighted row, the lowest-priced baggage fee ($400 US) can be achieved by distributing the bags such that traveler 1 has bags 1, 2, and 3, traveler 2 has bag 4, and traveler 3 has bag 5.

Referring again to FIG. 2, in step 208, computing system 101 compares the baggage fees for the enumerated baggage distribution patterns, and in step 209, selects the lowest-priced pattern. If multiple baggage patterns have the same lowest-price, computing system 101 will select the first pattern. Once the lowest-priced pattern has been selected, a decision is made, in step 210, about whether the fee for the selected baggage pattern is to be converted to a different currency. This option may be chosen via a pick-and-choose list when entering trip data into a client system 108, determined by computing system 101 based on the origin of the trip data, or determined by computing system 101 based on the country of the origin airport. If a currency conversion is desired, in step 211, computing system 101 accesses currency conversion store 104 to obtain an exchange rate for conversion to the desired currency. In step 212, the fee for the selected baggage pattern is converted by computing system 101 using the retrieved exchange rate.

Once the fee for the selected baggage pattern is converted, or if no conversion is performed, in step 213, computing system 101 transmits the selected baggage pattern and the associated fee to client system 108. Enhanced output may also be requested by a user through client system 108 during entry of trip data such that multiple options are to be transmitted to client system 108. One such option can include a request for a comprehensive list of all possible allowances and charges for a given itinerary. Once the selected baggage pattern and associated fee are transmitted to client system 108, travelers can follow the system-indicated baggage pattern.

It is to be understood that, while a number of the examples are described herein as operations running on, for example, computing system 101, the described operations can all be implemented in software stored in a computer-readable storage medium for access as needed to run such software on the appropriate processing hardware of a server or user computing device.

The examples noted here are only for illustrative purposes and there may be further implementation embodiments possible with a different set of components. While several embodiments are described, there is no intent to limit the disclosure to the embodiment or embodiments disclosed herein. On the contrary, the intent is to cover all alternatives, modifications, and equivalents obvious to the ones familiar with the art.

All aspects described here are illustrative and not restrictive and may be embodied in other forms without departing from their spirit and essential characteristics.

It is to be understood that the exact sequences of the various operations described herein may be altered based on design choice so long as the underlying method and functionality is not altered in a way that would create an incorrect result or eliminate a needed dependency.

In the foregoing specification, the invention is described with reference to specific embodiments thereof, but those skilled in the art will recognize that the invention is not limited thereto. Various features and aspects of the above-described invention may be used individually or jointly. Further, the invention can be utilized in any number of environments and applications beyond those described herein without departing from the broader spirit and scope of the specification. The specification and drawings are, accordingly, to be regarded as illustrative rather than restrictive. It will be recognized that the terms “comprising,” “including,” and “having,” as used herein, are specifically intended to be read as open-ended terms of art.

What is claimed is:

1. A method of determining airline baggage allowance and calculating baggage fees comprising:
receiving airline schedule information at a first computing system across a first network connection from a second computing system, the airline schedule information comprising schedule information for one or more airline;
storing the received airline schedule information in a schedule store;
receiving baggage rules at a first computing system across a second network connection from a third computing system, the baggage rules comprising baggage allowance information and baggage fee information for one or more airline;
storing the received baggage rules in a baggage rules store;
receiving trip data for two or more travelers each with one or more bag at a first computing system across a third network connection from a client system;
determining a bag travel route and a governing airline for the bag travel route by accessing the schedule store based on the received trip data;
determining applicable baggage allowance rules and applicable baggage fee rules for the bag travel route on the determined governing airline by accessing the baggage rules store based on the received trip data;
enumerating baggage distribution patterns of the two or more travelers, the one or more bag, and a bag order for the bag travel route on the determined governing airline;
calculating baggage fees for the enumerated patterns based on the determined applicable baggage allowance rules and the determined applicable baggage fee rules;
comparing the baggage fees for the enumerated patterns and selecting the pattern with a lowest-priced baggage fee; and
transmitting from the first computing system across the third network connection to the client system the selected pattern and the baggage fee for the selected pattern.

2. The method of claim 1 wherein the client system comprises an application accessed by an airline agent, a travel agent, a consumer agency representative, one of the two or more travelers, or a representative of one of the two or more travelers.

3. The method of claim 1 wherein the second computing system is operated by a provider of global airline information.

4. The method of claim 3 wherein the step of receiving airline schedule information occurs daily.

5. The method of claim 1 wherein the third computing system is operated by a publisher of airline fare information.

6. The method of claim 5 wherein the step of receiving baggage rules occurs hourly.

7. The method of claim 1 further comprising receiving currency conversion data, storing the currency conversion data, and converting the lowest-priced baggage fee to a different currency using the stored currency conversion data and wherein transmitting the selected pattern and the baggage free for the selected pattern comprises transmitting the selected pattern and the converted lowest-priced baggage fee.

8. The method of claim 1 wherein the trip data comprises one or more travel date, one or more flight number, one or more fare, one or more booking class, passenger status of the two or more travelers, dimensions of the one or more bag, type of the one or more bag, and weight of the one or more bag.

9. The method of claim 1 wherein the trip data comprises data obtained from a scanned barcode of a ticket.

10. The method of claim 1 wherein the bag travel route begins in one country and ends in another country.

11. The method of claim 1 wherein the bag travel route begins and ends in one country.

12. The method of claim 11 wherein the bag travel route includes an intermediary stop in another country.

13. The method of claim 1 wherein the schedule store and the baggage rules store are in a combined store.

14. A non-transitory computer readable medium having stored thereupon computing instructions comprising:
a code segment to receive airline schedule information at a first computing system across a first network connection from a second computing system, the airline schedule information comprising schedule information for one or more airline;
a code segment to store the received airline schedule information in a schedule store;
a code segment to receive baggage rules at a first computing system across a second network connection from a third computing system, the baggage rules comprising baggage allowance information and baggage fee information for one or more airline;
a code segment to store the received baggage rules in a baggage rules store;
a code segment to receive trip data for two or more travelers each with one or more bag at a first computing system across a third network connection from a client system;
a code segment to determine a bag travel route and a governing airline for the bag travel route by accessing the schedule store based on the received trip data;
a code segment to determine applicable baggage allowance rules and applicable baggage fee rules for the bag travel route on the determined governing airline by accessing the baggage rules store based on the received trip data;
a code segment to enumerate baggage distribution patterns of the two or more travelers, the one or more bag, and a bag order for the bag travel route on the determined governing airline;
a code segment to calculate baggage fees for the enumerated patterns based on the determined applicable baggage allowance rules and the determined applicable baggage fee rules;
a code segment to compare the baggage fees for the enumerated patterns and to select the pattern with a lowest-priced baggage fee; and
a code segment to transmit from the first computing system across the third network connection to the client system the selected pattern and the baggage fee for the selected pattern.

15. A baggage pricing system comprising:
a schedule store configured to store airline schedule information for one or more airline, the airline schedule information comprising schedule information for one or more airline;
a baggage rules store configured to store baggage rules for one or more airline, the baggage rules comprising baggage allowance information and baggage fee information for one or more airline; and
a computing system coupled to the schedule store, the baggage rules stores, and a client application communicating with the computing system by means of a web sendees XML interface, the computing system configured to receive trip data for two or more travelers each with one or more bag from the client application and to determine baggage allowance and baggage fees based on the airline schedule information retrieved from the schedule store, the baggage rules retrieved from the baggage rules store, and the trip data retrieved from the client application.

16. The baggage pricing system of claim 15 further comprising a currency conversion store configured to store currency conversion data comprising currency exchange rates, and wherein the computing system is coupled to the currency conversion store and is further configured to convert the baggage fees to a different currency based on the currency conversion data retrieved from the currency conversion store.
